(19) United States
(12) Patent Application Publication
(10) Pub. No.: US 2009/0324843 A1
(43) Pub. Date: Dec. 31, 2009

(54) PROCESS FOR PRODUCING MULTICOAT COLOR AND/OR EFFECT PAINT SYSTEMS

(75) Inventors: Egon Wegner, Greven (DE); Berthold Austrup, Nordkirchen (DE); Hubert Baumgart, Munster (DE); Michael Richert, Emsdetten (DE)

Correspondence Address: Mary E. Golota;Cantor Colburn LLP, 201 W. Big Beaver Road, Suite 1101, Troy, MI, 48084, US

(73) Assignee: BASF COATINGS AG, Munster (DE)

(21) Appl. No.: 12/305,230

(22) PCT Filed: Jun. 29, 2007
(86) PCT No.: PCT/EP2007/005792

§ 371 Date: May 14, 2009

(30) Foreign Application Priority Data
Jun. 29, 2006 (DE) 10 2006 030 059.9

(51) Int. Cl. C08J 7/18; B05D 3/02

(52) U.S. Cl. 427/514; 427/379

(57) ABSTRACT

Process for producing multicoat color and/or effect paint systems comprising a color and/or effect basecoat (A) and a transparent topcoat (B) by a wet-on-wet method using a color and/or effect coating material (A) and a transparent coating material (B), the coating material (A) being prepared by separately preparing an aqueous, structurally viscous powder dispersion (A1), in an amount, based on (A), of 50% to 100% by weight, mixing it with the other constituents (A2) of the coating material (A), and homogenizing the resulting mixtures (A).

### FIELD OF THE INVENTION

The present invention relates to a new process for producing multicoat color and/or effect paint systems.

### PRIOR ART

A process for producing multicoat color and/or effect paint systems which uses a color and/or effect basecoat material and a clearcoat material which can be cured by free-radical polymerization is known from German patent application DE 197 36 083 A1.

Free-radical polymerization, conventionally, is carried out with compounds which contain olefinically unsaturated double bonds. The free-radical polymerization can be initiated and maintained thermally or with actinic radiation.

Actinic radiation here and below means electromagnetic radiation, such as near infrared (NIR), visible light, UV radiation, X-radiation or gamma radiation, especially UV radiation, or particulate radiation, such as electron beams, proton beams, beta radiation, alpha radiation or neutron beams, especially electron beams.

The known process affords condensation-resistant multicoat color and/or effect paint systems whose basecoats and clearcoats are joined to one another with firm adhesion.

However, the constantly increasing requirements of the market, particularly the rising impositions of the automakers and their customers, in terms of multicoat color and/or effect paint systems are forcing the ongoing development of the performance properties of the multicoat color and/or effect paint systems, particularly with regard to leveling, gloss distinctiveness of image, stability of color locus, pigment orientation, particularly for platelet-shaped effect pigments, substrate adhesion, intercoat adhesion, stonechip resistance, abrasion resistance, scratch resistance, weathering stability, etch resistance, chemical stability, tree-resin resistance, condensation resistance, bird-dropping resistance, and recoatability.

The growing impositions are also, however, forcing continual development of the processes for producing multicoat color and/or effect paint systems, to allow their performance properties to be improved very specifically and to be best adapted to the requirements of the market. To this end it is necessary in particular that the processes can be varied broadly and yet still carried out on existing coating lines.

### PROBLEM ADDRESSED

It is an object of the present invention to provide a new process for producing multicoat color and/or effect paint systems comprising at least one color and/or effect basecoat (A) and at least one transparent topcoat (B) by
(1) applying at least one color and/or effect coating material (A) to an uncoated or coated substrate,
(2) drying the resulting color and/or effect film (A) without curing it completely,
(3) applying at least one transparent coating material (B) to the dried color and/or effect film (A) and
(4) curing at least the resulting transparent film (B) together with the color and/or effect film (A) to give the color and/or effect basecoat (A) and the transparent topcoat (B),
   said process no longer having the disadvantages of the prior art but instead being able to be varied broadly in terms of the curing methods and yet still carried out on existing lines, and affording multicoat color and/or effect paint systems which are significantly improved with regard to leveling, gloss, distinctiveness of image, stability of color locus, pigment orientation, particularly for platelet-shaped effect pigments, substrate adhesion, intercoat adhesion, stonechip resistance, abrasion resistance, scratch resistance, weathering stability, etch resistance, chemical stability, tree-resin resistance, condensation resistance, bird-dropping resistance, and recoatability, but particularly with regard to leveling and to distinctiveness of image.

### SOLUTION

Found accordingly has been the new process for producing multicoat color and/or effect paint systems comprising at least one color and/or effect basecoat (A) and at least one transparent topcoat (B), by
(1) applying at least one color and/or effect coating material (A) to an uncoated or coated substrate,
(2) drying the resulting color and/or effect film (A) without curing it completely,
(3) applying at least one transparent coating material (B) to the dried color and/or effect film (A) and
(4) curing at least the resulting transparent film (B) together with the color and/or effect film (A) to give the color and/or effect basecoat (A) and the transparent topcoat (B),
   which comprises preparing the color and/or effect coating material (A) or at least one of the color and/or effect coating materials (A) by
(5) separately preparing at least one aqueous, structurally viscous powder dispersion (A1), curable by free-radical polymerization, substantially or entirely free from volatile organic compounds, and comprising as its disperse phase solid and/or highly viscous particles (A111) which are dimensionally stable under storage and application conditions and have a z-mean average particle size as measured by photon correlation spectroscopy of 80 to 750 nm, the particles comprising at least one free-radically crosslinkable binder (A111) having a glass transition temperature of −70 to +50° C., an olefinically unsaturated double bond content of 2 to 10 eq/kg, and an acid group content of 0.05 to 15 eq/kg, in an amount, based on (A), of 50% to 100% by weight,
(6) mixing it with the other constituents (A2) of the color and/or effect coating material (A), and
(7) homogenizing the resulting mixture (A).

The new process for producing multicoat color and/or effect paint systems comprising at least one color and/or effect basecoat (A) and at least one transparent topcoat (B) is referred to below as the “process of the invention”.

### ADVANTAGES

In the light of the prior art it was surprising and unforeseeable for the skilled worker that the object on which the present invention was based could be achieved by means of the process of the invention.

In particular it was surprising that the process of the invention no longer had the disadvantages of the prior art but instead, in terms of the curing methods, could be varied broadly and yet still carried out on existing lines, and afforded outstandingly reproducible results.

Moreover, the process of the invention afforded multicoat color and/or effect paint systems which in terms of leveling, gloss, distinctiveness of image, stability of color locus, pigment orientation, particularly for platelet-shaped effect pigments, substrate adhesion, intercoat adhesion, stonechip resistance, abrasion resistance, scratch resistance, weathering stability, etch resistance, chemical stability, tree-resin resistance, condensation resistance, and bird-dropping resistance, but particularly in respect of leveling and distinctiveness of image, were significantly improved.

### DETAILED DESCRIPTION OF THE INVENTION

The process of the invention is used for producing multicoat color and/or effect paint systems which comprise at least one color and/or effect basecoat (A) and at least one topcoat (B). In addition they may comprise at least one further customary, known coating system such as single-coat or multicoat primer coats, electrodeposition coats, corrosion-control coats, antistonechip primer coats and/or surfacer coats, but especially electrodeposition coats and antistonechip primer coats or surfacer coats.

The color and/or effect basecoats (A) serve for coloring and/or for setting physical and/or chemical effects, examples being optical effects such as metallic effects, interference effects, flop effects or fluorescence, corrosion control, electrical conductivity, and magnetic shielding; in particular, however, they serve for coloring and/or for setting metallic effects, interference effects, and flop effects.

The transparent topcoats (B) may be clear and glossy or matted. They may also be tinted or colorless. Preferably they are colorless, clear, and glossy clearcoats (B).

The multicoat color and/or effect paint systems produced by the process of the invention may be on any of a very wide variety of substrates.

The substrates are preferably composed of metals, plastics, wood, ceramic, stone, textile, fiber composites, leather, glass, glass fibers, glass wool and rock wool, mineral-bound and resin-bound building materials, such as plasterboard and cement slabs or roofing shingles, and also composites of these materials.

Substrates in question are preferably
means of land, water or air transport which are operated by muscle power, hot air or wind, such as cycles, railroad trolleys, rowboats, sailboats, hot air balloons, gas balloons or sailplanes, and also parts thereof,
motorized means of land, water or air transport, such as motorcycles, utility vehicles or motor vehicles, especially automobiles, watergoing or underwater craft or aircraft, and also parts thereof,
stationary floating bodies, such as buoys or parts of harbor installations,
the interior and exterior of buildings,
doors, windows, and furniture, and
hollow glassware,
small industrial parts, such as nuts, bolts, hub caps or wheel rims,
containers, such as coils, freight containers or packaging,
electrical components, such as electronic windings, coils for example,
optical components,
mechanical components, and
white goods, such as household appliances, boilers, and radiators.

In particular the substrates are automobile bodies and parts thereof.

The process of the invention is what is called a wet-on-wet method, which involves
(1) applying at least one color and/or effect coating material (A) to an uncoated or coated substrate,
(2) drying the resulting color and/or effect film (A) without curing it completely,
(3) applying at least one transparent coating material (B) to the dried color and/or effect film (A) and
(4) curing at least the resulting transparent film (B) together with the color and/or effect film (A) to give the color and/or effect basecoat (A) and the transparent topcoat (B).

In process step (4) it is possible where appropriate to cure previously applied films as well, such as electrocoat films or surfacer films.

Methods of this kind are known (cf., for example, German patent application DE 100 27 292 A1, page 13, paragraph [0109], to page 14, paragraph [0118]).

In the course of these methods it is preferred to employ the customary, known spray application techniques.

For the process of the invention it is essential that the color and/or effect coating material (A) or at least one of the color and/or effect coating materials (A) is prepared by
(5) separately preparing at least one, especially one, aqueous, structurally viscous powder dispersion (A1), curable by free-radical polymerization, substantially or entirely free from volatile organic compounds, and comprising as its disperse phase solid and/or highly viscous particles (A11) which are dimensionally stable under storage and application conditions and have a z-mean average particle size as measured by photon correlation spectroscopy of 80 to 750 nm, the particles comprising at least one free-radically crosslinkable binder (A111) having a glass transition temperature of −70 to +50° C., an olefinically unsaturated double bond content of 2 to 10 eq/kg, and an acid group content of 0.05 to 15 eq/kg, in an amount, based on (A), of 50% to 100% by weight,
(6) mixing it with the other constituents (A2) of the color and/or effect coating material (A), and
(7) homogenizing the resulting mixture (A).

The powder dispersion (A1) is entirely or substantially free from organic solvents.

“Substantially free” means that the powder dispersion (A1) in question has a solvent content <10%, preferably in each case <5%, and in particular <2% by weight.

“Entirely free from” means that the solvent content is in each case below the customary, known detection limits for organic solvents.

The powder dispersion (A1) is structurally viscous.

The viscosity behavior referred to as “structurally viscous” describes a state which takes account, on the one hand, of the needs of application and also, on the other hand, of the requirements in terms of storage stability and settling stability of the power dispersion (A1). In the mobile state, such as when the powder dispersion (A1) is being pumped around in the circuit of a coating plant, for example, and during application, the powder dispersion (A1) adopts a low-viscosity state which ensures good processing properties. In the absence of shearing stress, in contrast, the viscosity increases. The higher viscosity in the immobile state, such as during storage, for instance, means that the settling of the solid particles (A11) of the powder dispersion (A1) is very largely prevented or ensures that, in the event of any slight settling and/or agglomeration during the storage period, the powder dispersion (A1) can be reestablished by agitation.

The structurally viscous behavior is set preferably by means of suitable thickeners (A112), especially nonionic and ionic thickeners (A112), which are preferably in the aqueous phase (A12) of the powder dispersion (A1).

For the structurally viscous behavior it is preferred to set a viscosity range of 50 to 1500 mPas at a shear rate of 1000 s⁻¹ and of 150 to 8000 mPas at a shear rate of 10 s⁻¹ and also of 180 to 12 000 mPas at a shear rate of 1 s⁻¹.

The powder dispersion (A1) comprises as its disperse phase solid and/or highly viscous, dimensionally stable particles (A11).

“Dimensionally stable” means that, under the customary, known conditions of the storage and application of structurally viscous, aqueous powder dispersions, the particles (A11) exhibit only slight agglomeration and/or breakdown into smaller particles, if any at all, but instead substantially or entirely preserve their original form even under the influence of shearing forces.

The particles (A11) have a z-mean average particle size as measured by photon correlation spectroscopy of 80 to 750 nm, preferably 80 to 600 nm, and in particular 80 to 400 nm.

Photon correlation spectroscopy is a customary, known method of measuring dispersed particles having sizes <1 μm. The measurement can be conducted, for example, by means of the Malvern® Zetasizer 1000.

The particle size distribution can be adjusted in any desired way. The particle size distribution results preferably from the use of suitable wetting agents (A112).

The amount of particles (A11) in the powder dispersion (A1) may vary very widely and is guided by the requirements of the case in hand.

Preferably the amount is 5% to 70%, more preferably 10% to 60%, very preferably 15% to 50%, and in particular 15% to 40% by weight, based on the powder dispersion (A1).

The particles (A11) comprise at least one, especially one, free-radically crosslinkable binder (A111) having
a glass transition temperature of −70 to +50° C., preferably −60 to +20° C., and in particular −60 to +10° C.,
an olefinically unsaturated double bond content of 2 to 10 eq/kg, preferably 2 to 8 eq/kg, more preferably 2.1 to 6 eq/kg, very preferably 2.2 to 6 eq/kg, with very particular preference 2.3 to 5 eq/kg, and in particular 2.5 to 5 eq/kg of the binder (A111), and
an acid group content of 0.05 to 15 eq/kg, preferably 0.08 to 10 eq/kg, more preferably 0.1 to 8 eq/kg, very preferably 0.15 to 5 eq/kg, with very particular preference 0.18 to 3 eq/kg, and in particular 0.2 to 2 eq/kg of the binder (A111).

The amount of acid groups is determined preferably via the acid number in accordance with DIN EN ISO 3682.

The particles (A11) contain the binders (A111) in an amount of 50% to 100%, preferably 55% to 100%, more preferably 60% to 99%, very preferably 70% to 99%, and in particular 80% to 99% by weight, based in each case on (A11).

The particles (A11) may therefore consist of the binder (A111). With preference the particles (A11) further comprise at least one of the additives (A112) described below.

The olefinically unsaturated double bonds of the binder (A111) are preferably in groups selected from the group consisting of (meth)acrylate, ethacrylate, crotonate, cinnamate, vinyl ether, vinyl ester, dicyclopentadienyl, norbornenyl, isoprenyl, isopropenyl, allyl or butenyl groups; dicyclopentadienyl ether, norbornenyl ether, isoprenyl ether, isopropenyl ether, allyl ether or butenyl ether groups; or dicyclopentadienyl ester, norbornenyl ester, isoprenyl ester, isopropenyl ester, allyl ester or butenyl ester groups, preferably (meth)acrylate groups. In particular the olefinically unsaturated double bonds are in acrylate groups.

The binders (A111) are oligomeric or polymeric.

“Oligomeric” means that the binder (A111) in question is composed of 3 to 12 monomeric structural units. The structural units may be alike or different.

“Polymeric” means that the binder (A111) in question is composed of more than 8 monomeric structural units. Here again, the structural units may be alike or different.

Whether a binder (A111) composed of 8 to 12 monomeric structural units is regarded as being an oligomer or a polymer depends primarily on its number-average molecular weight.

The number-average molecular weight of the binder (A111) may vary very widely and is guided by the requirements of the case in hand, in particular by the viscosity which is advantageous for the processing and the use of the binder (A111). The viscosity of the binder (A111), accordingly, is typically adjusted so that after the powder dispersion (A1) as such has been applied and the resulting wet film dried, filming of the particles (A11) is achieved easily and without problems.

The number-average molecular weight is preferably 1000 to 50 000 daltons, more preferably 1500 to 40 000 daltons, and in particular 2000 to 20 000.

The polydispersity of the molecular weight may likewise vary very widely and is preferably 1 to 10, in particular 1.5 to 8.

Suitable binders (A111) include all oligomers and polymers which have the profile of properties described above.

The binder (A111) is selected preferably from the group consisting of oligomeric and polymeric epoxy (meth)acrylates, urethane (meth)acrylates, and carbonate (meth)acrylates. Urethane (meth)acrylates are used in particular.

The urethane (meth)acrylates (A111) are preferably prepared by reacting
(a1) at least one compound containing at least two isocyanate groups and selected from the group consisting of aliphatic, aromatic or cycloaliphatic di- and polyisocyanates with
(a2) at least one compound having at least one, especially one, isocyanate-reactive functional group, selected preferably from the group consisting of hydroxyl groups, thiol groups, and primary and secondary amino groups, especially hydroxyl groups, and at least one, especially one, of the above-described groups which contain a free-radically polymerizable olefinically unsaturated double bond, preferably a (meth)acrylate group, in particular an acrylate group,
(a3) at least one compound having at least one, especially one, isocyanate-reactive functional group and at least one, especially one, acid group, selected preferably from the group consisting of carboxylic, phosphonic, phosphinic, sulfonic, and sulfinic acid groups, preferably carboxylic and sulfonic acid groups, especially carboxylic acid groups, and also
(a4) if desired, at least one compound having at least two, especially two, isocyanate-reactive functional groups.

Examples of suitable compounds (a1) are customary, known di- and polyisocyanates having an isocyanate functionality of on average 2 to 6, preferably 2 to 5, and in particular 2 to 4.

“Aliphatic” means that the isocyanate group in question is linked to an aliphatic carbon atom.

“Cycloaliphatic” means that the isocyanate group in question is linked to a cycloaliphatic carbon atom.

“Aromatic” means that the isocyanate group in question is linked to an aromatic carbon atom.

Examples of suitable aliphatic diisocyanates (a1) are aliphatic diisocyanates, such as tetramethylene diisocyanate, pentamethylene diisocyanate, hexamethylene diisocyanate, octamethylene diisocyanate, decamethylene diisocyanate, dodecamethylene diisocyanate, tetradecamethylene diisocyanate, derivatives of lysine diisocyanate, tetramethylxylylidene diisocyanate, trimethylhexane diisocyanate or 1,3- or 1,4-bis(isocyanatomethyl)cyclohexane.

Examples of suitable cycloaliphatic diisocyanates (a1) are 1,4-, 1,3- or 1,2-diisocyanatocyclohexane, tetramethylcyclohexane diisocyanate, bis(4′-isocyanato-cyclohexyl)methane, (4′-isocyanatocyclohexyl)(2′-isocyanatocyclohexyl)-methane, 2,2-bis(isocyanatocyclohexyl)propane, 2,2-(4′-isocyanatocyclohexyl)-(2′-isocyanato-cyclohexyl)propane, 1-isocyanato-3,3,5-trimethyl-5-(isocyanatomethyl)-cyclohexane (isophorone diisocyanate), 2,4- or 2,6-diisocyanato-1-methylcyclohexane or diisocyanates derived from dimer fatty acids, such as are sold under the tradename DDI 1410 by Henkel and described in patents WO 97/49745 and WO 97/49747, such as 2-heptyl-3,4-bis(9-isocyanatononyl)-1-pentylcyclohexane.

Examples of suitable aromatic diisocyanates (a1) are 2,4- or 2,6-tolylidene diisocyanate or their isomer mixtures, m- or p-xylylene diisocyanate, 2,4′- or 4,4′-diisocyanatodiphenylmethane or their isomer mixtures, 1,3- or 1,4-phenylene diisocyanate, 1-chloro-2,4-phenylene diisocyanate, 1,5-naphthylene diisocyanate, diphenylene 4,4′-diisocyanate, 4,4′-diisocyanato-3,3′-dimethylbiphenyl, 3-methyl-diphenylmethane 4,4′-diisocyanate, 1,4-diisocyanatobenzene or 4,4′-diisocyanato-diphenyl ether.

Preference is given to using aliphatic and cycloaliphatic diisocyanates (a1), especially hexamethylene diisocyanate, 1,3-bis(isocyanatomethyl)cyclohexane, isophorone diisocyanate and/or di(isocyanatocyclohexyl)methane.

Examples of suitable polyisocyanates (a1) are triisocyanates such as nonane triisocyanate (NTI) and also polyisocyanates (a1) based on the above-described diisocyanates and triisocyanates (a1), especially oligomers containing isocyanurate, biuret, allophanate, iminooxadiazinedione, urethane, carbodiimide, urea, uretonimine and/or uretdione groups. Examples of suitable such polyisocyanates (a1), and processes for preparing them, are disclosed for example in patents and patent applications CA 2,163,591 A 1, U.S. Pat. No. 4,419,513 A, U.S. Pat. No. 4,454,317 A, EP 0 646 608 A 1, U.S. Pat. No. 4,801,675 A, EP 0 183 976 A 1, DE 40 15 155 A 1, EP 0 303 150 A 1, EP 0 496 208 A 1, EP 0 524 500 A 1, EP 0 566 037 A 1, U.S. Pat. No. 5,258,482 A, U.S. Pat. No. 5,290,902 A, EP 0 649 806 A 1, DE 42 29 183 A 1 or EP 0 531 820 A 1.

Preference is given to using the oligomers (a1) of hexamethylene diisocyanate and of isophorone diisocyanate.

Examples of suitable compounds (a2) are the monoesters of
(a21) diols and polyols containing preferably 2 to 20 carbon atoms and at least 2 hydroxyl groups in the molecule, such as ethylene glycol, diethylene glycol, triethylene glycol, 1,2-propylene glycol, 1,3-propylene glycol, 1,1-dimethyl-1,2-ethanediol, dipropylene glycol, tripropylene glycol, tetraethylene glycol, pentaethylene glycol, 1,4-butanediol, 1,5-pentanediol, neopentyl glycol, 1,6-hexanediol, 2-methyl-1,5-pentanediol, 2-ethyl-1,4-butanediol, 1,4-dimethyl-olcyclohexane, 2,2-bis(4-hydroxycyclohexyl)propane, glycerol, trimethylol-ethane, trimethylolpropane, pentaerythritol, dipentaerythritol, ditrimethylol-propane, erythritol, sorbitol, polytetrahydrofuran having an average molecular weight of 162 to 2000, poly-1,3-propanediol having an average molecular weight of 134 to 400 or polyethylene glycol having a molecular weight of between 150 and 500, especially ethylene glycol; with
(a22) alpha,beta-unsaturated carboxylic acids, such as acrylic acid, methacrylic acid, crotonic acid, itaconic acid, fumaric acid, maleic acid, acrylamidoglycolic acid, and methacrylamidoglycolic acid, especially acrylic acid.

Further examples of suitable compounds (a2) are the monovinyl ethers of the above-described diols and polyols (a21).

Further examples of suitable compounds (a2) are the monoesters or monoamides of the above-described alpha,beta-unsaturated carboxylic acids (a22) with
(a23) amino alcohols, such as 2-aminoethanol, 2-(methylamino)ethanol, 3-amino-1-propanol, 1-amino-2-propanol or 2-(2-aminoethoxy)ethanol,
(a24) thioalcohols, such as 2-mercaptoethanol, or
(a25) polyamines, such as ethylenediamine or diethylenetriamine.

In particular, 2-hydroxyethyl acrylate is used.

Examples of suitable compounds (a3) are
(a31) hydroxycarboxylic acids, such as hydroxyacetic acid (glycolic acid), 2- or 3-hydroxypropionic acid, 3- or 4-hydroxybutyric acid, hydroxypivalic acid, 6-hydroxycaproic acid, citric acid, malic acid, tartaric acid, 2,3-dihydroxypropionic acid (glyceric acid), dimethylolpropionic acid, dimethylolbutyric acid, trimethylolacetic acid, salicylic acid, 3- or 4-hydroxybenzoic acid or 2-, 3- or 4-hydroxycinnamic acid,
(a32) amino acids, such as 6-aminocaproic acid, aminoacetic acid (glycine), 2-aminopropionic acid (alanine), 3-aminopropionic acid (beta-alanine) or the other essential amino acids; N,N-bis(2-hydroxyethyl)glycine, N-[bis(hydroxymethyl)-methyl]glycine or imidodiacetic acid,
(a33) sugar acids, such as gluconic acid, glucaric acid, glucuronic acid, galacturonic acid or mucic acid (galactaric acid),
(a34) thiol carboxylic acids, such as mercaptoacetic acid, or
(a35) sulfonic acids, such as 2-aminoethanesulfonic acid (taurine), aminomethanesulfonic acid, 3-aminopropanesulfonic acid, 2-[4-(2-hydroxyethyl)-1-piperazinyl]ethanesulfonic acid, 3-[4-(2-hydroxyethyl)piperazinyl]propanesulfonic acid, N-[tris(hydroxymethyl)methyl]-2-aminoethanesulfonic acid, N,N-bis(2-hydroxyethyl)-2-aminoethanesulfonic acid, 5-sulfosalicylic acid, 8-hydroxyquinoline-5-sulfonic acid, phenol-4-sulfonic acid or sulfanilic acid.

In particular, hydroxyacetic acid (glycolic acid) (a31) is used.

The acid groups may be in ionized form.

Examples of suitable counterions are lithium, sodium, potassium, rubidium, cesium, magnesium, strontium, barium or ammonium ions and also primary, secondary, tertiary or quaternary ammonium ions deriving from customary, known organic amines.

Examples of suitable compounds (a4) are the above-described diols and polyols (a21), amino alcohols (a23), thioalcohols (a24) or polyamines (a25).

The urethane (meth)acrylates (A111) are preferably prepared by reacting compounds (a1), (a2) and (a3) and also, if desired, (a4) with one another in a molar ratio such that for 3 equivalent isocyanate groups from the compound (a1) there are
0.5 to 3, preferably 0.8 to 2.5, more preferably 1.0 to 2.2, and in particular 1.4 to 1.8 equivalents of isocyanate-reactive functional groups from compound (a2) and
0.001 to 1.5, preferably 0.005 to 1.0, more preferably 0.01 to 0.8, and in particular 0.1 to 0.5 equivalents of isocyanate reactive functional groups from the compound (a3), and, if desired,
0 to 2, preferably 0.1 to 1.8, more preferably 0.5 to 1.5, and in particular 0.8 to 1.3 equivalents of isocyanate-reactive functional groups from the compound (a4).

It is also possible, however to use urethane (meth)acrylates (A111) which are prepared from at least one reaction product having an epoxide group content (calculated as M=42 daltons)<0.2% and an acid number <10, preferably <6, and in particular <4 mg KOH/g, which are preparable from at least one olefinically unsaturated carboxylic acid and at least one glycidyl ester of an unsaturated carboxylic acid, and also from at least one polyisocyanate.

One example of an especially suitable reaction product is that of acrylic acid with glycidyl methacrylate. Very especially suitable reaction products of this kind contain, based in each case on their respective overall amount, at least 60%, preferably at least 70%, and in particular at least 80% by weight of a mixture of 3-acryloyloxy-2-hydroxypropyl methacrylate and 2-acryloyloxy-3-hydroxypropyl methacrylate.

The urethane (meth)acrylates (A111) and also the processes for preparing them are described in detail in German patent application DE 10357712 A1, page 3, paragraph [0008], page 3, paragraph [0011], to page 5, paragraph [0022], and also page 9, examples, paragraph [0050], to page 13, paragraph [0061], page 14, paragraph [0067], and page 15, paragraph [0070], to page 16, paragraph [0075].

Viewed in terms of method the preparation of the urethane (meth)acrylates (A111) has no peculiarities but instead takes place under the customary, known conditions of the reaction of polyisocyanates in the absence of water at temperatures of 5 to 100° C. In order to inhibit polymerization of the olefinically unsaturated double bonds it is preferred to operate under an oxygenous gas, in particular under air or air/nitrogen mixtures.

The powder dispersion (A1) is composed of at least one disperse phase (A11) and a continuous phase (A12). In the simplest case the disperse phase (A11) is composed of the binder (A111) and the continuous phase (A12) is composed of water. Preferably, however, the powder dispersion (A1) further comprises at least one customary, known additive (A112) in customary, known amounts.

Depending on its physicochemical properties an additive (A112) may be in the disperse phase (A11), i.e., the dimensionally stable particles (A11); alternatively it may also form a separate disperse phase (A13), such as a pigment, for example. In addition it may be exclusively in the aqueous phase (A12), such as a water-soluble salt, for example, or may accumulate at the interface between aqueous phase (A12) and disperse phase (A11), such as a wetting agent, for example. It is possible not least for the additive (A112) to partition itself between the disperse phase (A11) and the aqueous phase (A12), such as a molecularly dispersely dissolved organic dye, for example. The skilled worker therefore has the capacity to predict, simply, how an additive (A112) will behave in the powder dispersion (A1).

The additive (A112) is preferably selected from the group consisting of salts which can be decomposed thermally without, or substantially without, residue; binders other than the binders (A111) and curable physically, thermally and/or with actinic radiation; thermally curable crosslinking agents; neutralizing agents; thermally curable reactive diluents; reactive diluents curable with actinic radiation; opaque and transparent, color and/or effect pigments, especially organic and inorganic metallic effect pigments, interference pigments, fluorescent pigments, electrically conductive pigments, magnetically shielding pigments, and corrosion-inhibiting pigments; molecularly dispersely soluble dyes; opaque and transparent organic and inorganic fillers; organic and inorganic nanoparticles; light stabilizers; antioxidants; devolatilizers; wetting agents; emulsifiers; slip additives; polymerization inhibitors; free-radical polymerization initiators, especially photoinitiators; thermolabile free-radical initiators; adhesion promoters; flow control agents; film-forming assistants; rheological assistants, such as thickeners and structurally viscous sag control agents, SCAs; flame retardants; corrosion inhibitors; free-flow aids; waxes; siccatives; biocides; and matting agents.

With preference the powder dispersion (A1) comprises salts which can be decomposed thermally without, or substantially without, residue, light stabilizers, wetting agents, emulsifiers, flow control agents, photoinitiators or thermolabile free-radical initiators, and rheological assistants as additives (A112).

Examples of suitable additives (A112) are known from German patent applications
DE 101 26649 A1, page 16, paragraph [0145], to page 18, paragraph [0189],
DE 100 27 270 A1, page 11, paragraph [0106] and [0107] or
DE 101 35 997 A1, page 3, paragraph [0022], to page 4, paragraph [0033], and page 4, paragraphs [0039] and [0040], page 10, paragraphs [0092] to [0101],

Where the powder dispersion (A1) includes thermally curable constituents (A112) they are present in the dimensionally stable particles (A11) preferably in an amount <40%, more preferably <30%, and in particular <20% by weight.

The powder dispersion (A1) is prepared preferably by the secondary dispersion process known from German patent application DE 199 08 013 A1, German patent DE 198 41 842 C2 or German patent application DE 100 55 464 A1.

In that process the binders (A111) and also, if desired, the additives (A112) are dissolved in organic solvents, particularly water-miscible solvents which are highly volatile. The resulting solutions are dispersed with the aid of neutralizing agents (A112) in water (A12). Dilution then takes place with water (A12), accompanied by stirring. The initial product is a water-in-oil emulsion, which on further dilution undergoes inversion to give an oil-in-water emulsion. This inversion point is generally reached at solids contents of <50% by weight, based on the emulsion, and can be recognized externally from a relatively sharp drop in viscosity in the course of dilution.

The oil-in-water emulsion can also be prepared directly by the melt emulsification of the binders (A111) and also, where appropriate, of the additives (A112) in water (A12).

It is of advantage in this context if the wetting agents (A112) are added to the organic solution and/or to the water (A12) before or during emulsification. Preferably they are added to the organic solution.

The emulsion thus obtained, which still contains solvents, is subsequently freed from solvents by means of azeotropic distillation.

In accordance with the invention it is of advantage if the solvents to be removed are distilled off at a distillation temperature below 70° C., preferably below 50° C., and in particular below 40° C. Where appropriate the distillation pressure in this case is chosen such that in the case of relatively high-boiling solvents the temperature is maintained within this range.

In the simplest case the azeotropic distillation can be brought about by stirring the emulsion at room temperature in the open vessel for a number of days. In the preferred case the solvent-containing emulsion is freed from the solvents by means of vacuum distillation.

In order to avoid high viscosities, the quantity of water and solvents removed by evaporation or distillation is replaced by water (A12). The water (A12) can be added before, after or else during the evaporation or distillation, in portions.

Following the loss of solvents there is a rise in the glass transition temperature of the dispersed dimensionally stable particles (A11), and instead of the previous solvent-containing emulsion the structurally viscous aqueous powder dispersion (A1) is formed.

Where appropriate the dimensionally stable particles (A11) are mechanically comminuted in the wet state, an operation also referred to as wet grinding. In this context it is preferred to employ conditions such that the temperature of the material for grinding does not exceed 70° C., more preferably 60° C., and in particular 50° C. The specific energy input during the grinding operation is preferably 10 to 1000, more preferably 15 to 750, and in particular 20 to 500 Wh/g.

Wet grinding can be carried out employing any of a very wide variety of apparatus, which generate high or low shear fields.

Examples of suitable apparatus generating low shear fields are customary, known stirred tanks, slot homogenizers, microfluidizers or dissolvers.

Examples of suitable apparatus generating high shear fields are customary, known agitator mills or inline dissolvers.

Particular preference is given to employing apparatus which generate high shear fields. Of these apparatus, the agitator mills are particularly advantageous in accordance with the invention and are therefore used with very particular preference.

In the case of wet grinding, generally speaking, the powder dispersion (A1) is supplied to the above-described apparatus with the aid of suitable devices, such as pumps, especially gear pumps, and is circulated via said apparatus until the desired particle size has been reached.

The powder dispersion (A1) is preferably filtered before being used. This is done using the customary, known filtration equipment and filters. The mesh size of the filters may vary widely and is guided primarily by the particle size and particle size distribution. The skilled worker is therefore able easily to determine the appropriate filters on the basis of this physical parameter. Examples of suitable filters are monofilament flat filters or bag filters. They are available on the market under the brand names Pong® or Cuno®.

The above-described powder dispersion (A1) is mixed, as part of the process of the invention, in process step (6) with the other constituents (A2) of the color and/or effect coating material (A), after which the resulting mixture (A) is homogenized in process step (7).

The amount of the powder dispersion (A1) which is used as part of the process of the invention can be varied broadly and so adapted outstandingly to the requirements of the case in hand. The amount of powder dispersion (A1) used is preferably such that the color and/or effect coating material (A), based on its overall amount, contains 1% to 20% by weight, preferably 2% to 17.5% by weight, and in particular 5% to 15% by weight of the binders (A111).

Examples of suitable constituents (A2) which can be used with advantage for preparing the color and/or effect coating material (A) are known from international patent application WO 92/15405, page 2, line 35, to page 12, line 14, from German patent applications
DE 44 37 535 A1, page 2, line 24, to page 6, line 59,
DE 199 14 98 A1, column 4, line 23, to column 15, line 63,
DE 199 48 004 A1, page 3, line 14, to page 17, line 5,
   and from German patent DE 100 43 405 C1, column 5, paragraphs [0030] to [0033] and column 9, paragraph [0062], to column 11, paragraph [0070]. Preferably they are used in the customary, known effective amounts.

The color and/or effect film (A) which results in process step (1) is dried in process step (2) without being cured completely.

Drying can be accelerated through the use of a gaseous, liquid and/or solid, hot medium, such as hot air, heated oil or heated rolls, or of microwave radiation, infrared light and/or near infrared (NIR) light. Preferably the wet film is dried in a forced-air oven at 23 to 150° C., more preferably 30 to 120° C., and in particular 50 to 100° C.

In accordance with the invention it is of advantage to expose the color and/or effect film (A) to actinic radiation, especially UV radiation, prior to process step (3). This can be done using the customary, known methods and apparatus that are described below. Exposure can be carried out employing a dose which is sufficient for the complete free-radical polymerization of the free-radically polymerizable, olefinically unsaturated double bonds present. Preferably, however, a dose is used at which not all of the free-radically polymerizable, olefinically unsaturated double bonds present undergo free-radical polymerization.

The color and/or effect coating material (A) is preferably applied in process step (1) in a wet film thickness such that complete curing of the color and/or effect film (A) in process step (4) results in a film thickness of 5 to 25 μm, preferably 5 to 20 μm, and in particular 5 to 15 μm.

In process step (3) the color and/or effect film (A) is coated with at least one transparent coating material (B).

The transparent coating material (B) may have a composition such that complete curing of the transparent film (B) in process step (4) results in a transparent topcoat (B) which is clear, glossy, matted, tinted or colorless. The transparent topcoat (B) is preferably a colorless, clear, and glossy clearcoat.

As transparent coating materials (B) it is therefore preferred to use the customary, known clearcoat materials curable thermally, with actinic radiation, or both thermally and with actinic radiation (dual cure). Examples of suitable clearcoat materials are known from German patent DE 100 43 405 C1, column 8, paragraph [0054], or from German patent application DE 199 48 004 A1, page 18, lines 7 to 30.

In process step (3) the transparent coating materials (B) are applied in a wet film thickness such that their complete curing in process step (4) results in a film thickness of preferably 10 to 100 μm, more preferably 20 to 80 μm, and in particular 25 to 70 μm.

In process step (4) at least the above-described films (A) and (B) are jointly cured.

It is a great advantage of the process of the invention that the curing can take place not only by dual cure but also, if necessary, by means of heat alone. This is particularly important when complete curing is intended also to apply in the shadow zones of substrates of three-dimensionally complex form such as automobile bodies.

Viewed in terms of method, the thermal curing has no peculiarities but can instead be carried out by means of the above-described apparatus and methods.

In terms of method the actinic radiation cure has no special features but may instead be carried out by means of the customary, known apparatus and techniques, as are described for example in German patent application DE 198 18 735 A 1, column 10, lines 31 to 61, German patent application DE 102 02 565 A1, page 9, paragraph [0092], to page 10, paragraph [0106], German patent application DE 103 16 890 A1, page 17, paragraphs [0128] to [0130], international patent application WO 94/11123, page 2, line 35, to page 3, line 6, page 3, lines 10 to 15, and page 8, lines 1 to 14, or the U.S. Pat. No. 6,743,466 B2, column 6, line 53, to column 7, line 14.

The multicoat color and/or effect paint systems produced in a procedure of the invention meet all of the requirements which are imposed on automotive finishes (cf. European patent EP 0 352 298 B1, page 15, line 42, to page 17, line 40) and in terms of their appearance correspond fully to a Class A surface.

### EXAMPLES

### Preparation Example 1

### The Preparation of the Powder Dispersion (A1-1) Curable by UV-Initiated Free-Radical Polymerization

For the preparation of the powder dispersion (A1-1) first of all the binder (A111-1) was prepared in the manner set out below.

Isopropenylidenedicyclohexanol was coarsely dispersed in hydroxyethyl acrylate at 60° C. with stirring. Added to this suspension were the polyisocyanates, pentaerythritol tri/tetra-acrylate, hydroquinone monomethyl ether, 1,6-di-tert-butyl-p-cresol, and methyl ethyl ketone. After dibutyltin dilaurate had been added the reaction mixture became hotter. It was stirred at 75° C. for a number of hours until the free isocyanate group content was constant. Then glycolic acid and methanol were added and the mixture was stirred until free isocyanate groups were no longer detectable.

The hydroxyl-containing compounds and the polyisocyanates were used in amounts such as to give the equivalents ratios listed below:

| Isopropenylidenedicyclohexanol | 33.7 | eq OH |
|---|---|---|
| 2-Hydroxyethyl acrylate | 24.7 | eq OH |
| Pentaerythritol tri/tetraacrylate | 24.7 | eq OH |
| (average OH number: | | |
| 100 to 111 mg KOH/g) | | |
| Basonat ® HI 100 from BASF AG | 56.25 | eq NCO |
| Allophanate of hexamethylene | 18.75 | eq NCO |
| diisocyanate and 2-hydroxyethyl | | |
| acrylate in accordance with | | |
| international | | |
| patent application WO 00/39183 | | |
| Desmodur ® W from Bayer AG | 25 | eq NCO |
| Hydroquinone monomethyl ether | 0.05% by weight based on solids | |
| 1,6-Di-tert-butyl-p-cresol | 0.1% by weight based on solids | |
| Methyl ethyl ketone | corresponding to a solids content | |
| | of 70% by weight | |
| Dibutyltin dilaurate | 0.02% by weight based on solids | |
| Glycolic acid | 6.8 | eq OH |
| Methanol | 10.1 | eq OH |

The urethane (meth)acrylate (A111-1) had a solids content of 70% by weight, a glass transition temperature of 2.5° C., an olefinically unsaturated double bond content of 2.93 eq/kg, and an acid number of 18.85 mg KOH/g.

Additionally, the urethane (meth)acrylate (A111-2) was prepared in the manner described above, except that Desmodur® W was replaced by the equivalent amount of allophanate formed from hexamethylene diisocyanate and 2-hydroxyethyl acrylate in accordance with international patent application WO 00/39183. The urethane (meth)acrylate (A111-2) had a solids content of 71% by weight, a glass transition temperature of 12.3° C., an olefinically unsaturated double bond content of 3 eq/kg, and an acid number of 15.8 mg KOH/g

The powder dispersion (A1-1) was prepared by means of the secondary dispersion process, by mixing the constituents below in the order stated, distilling off the organic solvents, substituting water for the organic solvents removed, and homogenizing the resulting mixture:
751.123 parts by weight of urethane (meth)acrylate (A111-1),
493.696 parts by weight of urethane (meth)acrylate (A111-2),
26.289 parts by weight of methyl ethyl ketone,
12.137 parts by weight of Lutensol® AT 50 (commercial wetting agent from BASF Aktiengesellschaft),
20.861 parts by weight of triethylamine,
a total of 35.052 parts by weight of Irgacure® 184 (commercial photoinitiator from Ciba Specialty Chemicals) and Lucirin® TPO (commercial photoinitiator from BASF Aktiengesellschaft) in a weight ratio of 5:1,
1660.842 parts by weight of deionized water,
24 parts by weight of Acrysol® RM-8W (commercial associative thickener from Rohm and Haas), and
24 parts by weight of deionized water.

### Preparation Example 2

### The Preparation of the Powder Dispersion (A1-2) Curable by Thermally Initiated Free-Radical Polymerization

The powder dispersion (A1-2) was prepared by means of the secondary dispersion process, by mixing the constituents below in the order stated, distilling off the organic solvents, substituting water for the organic solvents removed, and homogenizing the resulting mixture:
755.198 parts by weight of urethane (meth)acrylate (A111-1),
496.374 parts by weight of urethane (meth)acrylate (A111-2),
52.864 parts by weight of methyl ethyl ketone,
12.203 parts by weight of Lutensol® AT 50 (commercial wetting agent from BASF Aktiengesellschaft),
20.974 parts by weight of triethylamine,
13.745 parts by weight of Initiator BK (oligomeric benzpinacol silyl ether in triethyl phosphate/toluene, from Bayer Distribution Service GmbH),
13.216 parts by weight of the commercial flow control additive Byk® N from Byk Chemie,
1635.428 parts by weight of deionized water,
24 parts by weight of Acrysol® RM-8W (commercial associative thickener from Rohm and Haas), and
24 parts by weight of deionized water.

### Preparation Example 3

### The Preparation of the Powder Dispersion (A1-3) Curable by Thermally Initiated Free-Radical Polymerization

For preparing the powder dispersion (A1-3), first of all the urethane (meth)acrylate (A111-3) was prepared, in accordance with the following instructions:

9290 g of glycidyl methacrylate, 70 g of triphenylphosphine and 14 g of 2,6-di-tert-butyl-4-methylphenol were charged to a suitable stirred vessel. Air was passed through the mixture at 5 l/h and over the mixture at 101/h. The mixture was heated to 70° C. with stirring. At that temperature 4710 g of acrylic acid were metered in over the course of five hours. The temperature rose initially to 81° C. After the exothermic heat had subsided, the reaction mixture was held at 65 to 70° C. After the end of the addition the temperature was raised to 90° C. After six hours at 90° C. a sample taken was found by measurement to have an acid number of 9.4 mg KOH/g. Subsequently a further 14 g of triphenylphosphine were added. After a further six hours at 90° C. a sample taken was found by measurement to have an acid number of 1.8 mg KOH/g. The reaction mixture is stirred at 90° C. for a further 24 hours and then its epoxide content was measured. It was 0.1% by weight.

In a reaction vessel suitable for the reaction of polyisocyanates, with stirrer and gas inlet tube, 1724.22 g of a polyisocyanate based on hexamethylene diisocyanate (Desmodur® XP 2410 from Bayer AG), 1155 g of butyl acetate, 4.09 g of 2,6-di-tert-butyl-4-methylphenol and 2.04 g of a tin catalyst (Desmorapid® Z from Bayer AG) were introduced along with 0.3 l/h air, and this initial charge was heated to 60° C. with stirring. At that temperature 2304.65 g of the above-described reaction product were metered into the initial charge with stirring over the course of two hours. The resulting reaction mixture was stirred at 60° C. for a further 10 hours until an isocyanate content <0.1% by weight was reached. The resulting urethane (meth)acrylate (A111-3) had a solids content of 76.6% by weight, a glass transition temperature of 2° C., an acid number of 20 mg KOH/g, and an olefinically unsaturated double bond content of 3.89 eq/kg.

The powder dispersion (A1-3) was prepared by means of the secondary dispersion process, by mixing the constituents (in solution in methyl ethyl ketone) below in the order stated, distilling off the organic solvents, substituting water for the organic solvents removed, and homogenizing the resulting mixture:
1021.995 parts by weight of urethane (meth)acrylate (A111-3),
9.866 parts by weight of Lutensol® AT 50 (commercial wetting agent from BASF Aktiengesellschaft),
20.974 parts by weight of triethylamine,
11.13 parts by weight of Initiator BK (oligomeric benzpinacol silyl ether in triethyl phosphate/toluene, from Bayer Distribution Service GmbH),
10.4 parts by weight of the commercial flow control additive Byk® N from Byk Chemie,
1327.372 parts by weight of deionized water,
19.2 parts by weight of Acrysol® RM-8W (commercial associative thickener from Rohm and Haas), and
19.2 parts by weight of deionized water.

### Examples 1 to 3 (Inventive) and C1 (Comparative)

### The Production of Multicoat Color Paint Systems 1 to 3 and C1 (Examples 1 to 3 and C1)

For the production of the multicoat color paint systems 1 to 3 of Examples 1 to 3, basecoat materials 1 to 3 were prepared first of all.

### Basecoat Material 1:

8.1 parts by weight of a 3% strength by weight aqueous solution of a synthetic sodium magnesium phyllosilicate (Laponite® from Laporte), 10 parts by weight of deionized water and 0.14 part by weight of trimethylamine were charged to a vessel. A mixture of 6.5 parts by weight of deionized water and Viscalex® HV 30 (commercial associative thickener from Ciba Specialty Chemicals, based on a methacrylate copolymer) was added, after which the resulting mixture was homogenized. Subsequently a mixture of 0.4 part by weight of Nopco® DSX 1550 (commercial associative thickener from Cognis Deutschland GmbH based on a hydrophobic polyurethane) and 7.8 parts by weight of deionized water were added, after which the resulting mixture was homogenized.

With this as an initial batch, a mixture was metered in of 33.9 parts by weight of the powder dispersion (A1-1) from Preparation Example 1, 0.3 part by weight of tetramethyldecynediol (50 percent strength in butyl glycol), 9.45 parts by weight of a carbon black paste prepared from
57 parts by weight of the acrylated polyurethane dispersion of German patent application DE 44 37 535 A1,
2 parts by weight of polypropylene glycol,
25 parts by weight of deionized water,
10 parts by weight of Monarch 1400 carbon black, and
6 parts by weight of neutralizing solution (dimethylethanolamine, 10 percent strength in water);

2.6 parts by weight of butyl glycol, 2.4 parts by weight of 1-propoxy-2-propanol, 1.2 parts by weight of Solventnaphtha®, and 2.4 parts by weight of Shellsol® T, after which the resulting mixture was homogenized.

Metered into this mixture was a solution of one part by weight of Pripol® 2033 (commercial fatty diol from Uniqema) in 2.4 parts by weight of 1-propoxy-2-propanol, after which the resulting mixture was again homogenized.

Finally a mixture was added of 3.3 parts by weight of a talc paste prepared from
48.2 parts by weight of the acrylated polyurethane dispersion of German patent application DE 44 37 535 A1,
3 parts by weight of polypropylene glycol,
28 parts by weight of talc,
19 parts by weight of deionized water,
1.4 parts by weight of the commercial dispersant Disperbyk® 184 from Byk Chemie, and
neutralizing solution (dimethylethanolamine, 10 percent strength in water), corresponding to a pH of 8,

2 parts by weight of tributyl phosphate, and 0.66 part by weight of deionized water, after which the resulting basecoat material 1 was homogenized. Basecoat material 1 was used to produce multicoat paint system 1.

### Basecoat Material 2:

Basecoat material 2 was prepared in the same way as basecoat material 1 but replacing the powder dispersion (A1-1) of Preparation Example 1 by the powder dispersion (A1-2) of Preparation Example 2. Basecoat material 2 was used to produce multicoat paint system 2.

### Basecoat Material 3:

Basecoat material 3 was prepared in the same way as basecoat material 1 but replacing the powder dispersion (A1-1) of Preparation Example 1 by the powder dispersion (A1-3) of Preparation Example 3. Basecoat material 3 was used to produce multicoat paint system 3.

For Example C1, basecoat material C1 was prepared in the same way as in the instructions for preparing basecoat material 1, except that instead of the powder dispersion (A1-1) 33.9 parts by weight of an aqueous polyurethane resin dispersion were used. Basecoat material C1 was used to produce multicoat paint system C1.

Two series of the multicoat color paint systems 1 to 3 and C1 were produced.

Test panels used for the first series were smooth steel panels which had been coated with a customary, known, cathodically deposited, and baked, smooth electrocoat.

Test panels used for the second series were rough steel panels which had been coated with a customary, known, cathodically deposited, and baked, rough electrocoat.

Atop the electrocoats were applied, in the case of both series, a coat, respectively, of basecoat materials 2, 3, and C1. Following their application, the basecoat films 2, 3, and C1 were each subjected to initial drying at 80° C. for 10 minutes.

Furthermore, for both series, a coat of a commercial aqueous surfacer (Colorpro® I from BASF Coatings AG) was applied and the film was dried at 80° C. for 10 minutes. Atop this film was applied a film of the basecoat material 1. The resulting basecoat film 1 was likewise dried at 80° C. for 10 minutes and then exposed in air to UV radiation with a dose of 1.5 J/cm² (iron-doped mercury vapor lamp from IST; dose measured with Light Bug C).

Subsequently, atop the dried basecoat films 2, 3, and C1 and the dried and UV-exposed basecoat film 1, a coat of a commercial clearcoat material (ProGloss® from BASF Coatings AG) was applied. The resulting clearcoat films were cured jointly with the basecoat films 1 to 3 and C1 at 140° C. for 20 minutes.

Multicoat paint system 1 had the following construction:
electrocoat 20±2 μm,
functional coat or surfacer 15±2 μm,
basecoat 12±2 μm, and
clearcoat 35±5 μm.

Multicoat paint systems 2 and 3 and C1 had the following construction:
electrocoat 20±2 μm,
basecoat 18±2 μm, and
clearcoat 35±5 μm.

Basecoats 1 to 3 and C1 of multicoat paint systems 1 to 3 and C1 exhibited a high popping limit of >20 μm. Their intercoat adhesion was outstanding (cross-cut test: GT0) both before and after moisture exposure over 240 hours in the constant climate conditions test. The stonechip resistance as well was very good (VDA: rating 2 to 2.5).

The leveling and the distinctiveness of image (DOI) of the multicoat paint systems 1 to 3 was compared with the leveling and the distinctiveness of image (DOI) of multicoat paint system C1. The results have been compiled in the table, with only the change in the values relative to those of the multicoat paint system C1 (acting as standard) being reported.

TABLE
The leveling and the distinctiveness of image (DOI) of
multicoat paint systems 1 to 3 of Examples 1 to 3 in comparison
to the leveling and the distinctiveness of image (DOI)
of multicoat paint system C1 of Example C1

| | Multicoat paint system: | | |
|---|---|---|---|
| Property | 1 | 2 | 3 |

Leveling:

| | | | |
|---|---|---|---|
| 1st series: | | | |
| Longwave | −4.2 | −4.2 | −3.7 |
| Shortwave | −11.3 | −11.2 | −15.5 |
| 2nd series: | | | |
| Longwave | −4 | −3.9 | −5.5 |
| Shortwave | −8.2 | −8.3 | −9.3 |

Distinctiveness of image (DOI):

| | | | |
|---|---|---|---|
| 1st series: | 1.4 | 1.5 | 4.1 |
| 2nd series: | 1.4 | 1.4 | 1.6 |

The results in the table underlined the fact that the multicoat paint systems 1 to 3 exhibited considerably better leveling and a significantly higher distinctiveness of image (DOI) than the multicoat paint system C1, and so were capable to a very much improved degree of compensating for unevennesses in substrates, which had come about, for example, as a result of poorer steel quality or a poorer leveling of the electrocoat. It also resulted in a very much better leveling and a better distinctiveness of image (DOI) on the part of the respective clearcoats.

1. A process for producing a multicoat color and/or effect paint system comprising at least one color and/or effect basecoat (A) and at least one transparent topcoat (B), the process comprising
(1) applying at least one color and/or effect coating material (A) to an uncoated or coated substrate to provide an applied coating material (A),
(2) drying the applied coating material (A) without curing it completely to provide a dried color and/or effect film (A),
(3) applying at least one transparent coating material (B) to the dried color and/or effect film (A) to provide an applied transparent coating material (B), and
(4) curing at least the applied transparent coating material (B) together with the color and/or effect film (A) to give a color and/or effect basecoat (A) and a transparent topcoat (B),
wherein the at least one color and/or effect coating material (A) is prepared by
(5) separately preparing at least one aqueous, structurally viscous powder dispersion (A1), curable by free-radical polymerization, substantially or entirely free from volatile organic compounds, and comprising as its disperse phase solid and/or highly viscous particles (A11) which are dimensionally stable under storage and application conditions and have a z-mean average particle size as measured by photon correlation spectroscopy of 80 to 750 nm, the particles comprising at least one free-radically crosslinkable binder (A 111) having a glass transition temperature of −70 to +50° C., an olefinically unsaturated double bond content of 2 to 10 eq/kg, and an acid group content of 0.05 to 15 eq/kg, in an amount, based on (A), of 50% to 100% by weight,
(6) mixing it with other constituents (A2) of the color and/or effect coating material (A), and
(7) homogenizing the resulting mixture (A).

2. The process of claim 1, wherein the binder (A 111) of the dimensionally stable particles (A11) of the powder dispersion (A1) has a number-average molecular weight of 1000 to 50 000 daltons.

3. The process of claim 1, wherein the olefinically unsaturated double bonds of the binders (A 111) of the dimensionally stable particles (A11) of the powder dispersion (A1) are in groups selected from the group consisting of (meth)acrylate, ethacrylate, crotonate, cinnamate, vinyl ether, vinyl ester, dicyclopentadienyl, norbornenyl, isoprenyl, isopropenyl, allyl or butenyl groups; dicyclopentadienyl ether, norbornenyl ether, isoprenyl ether, isopropenyl ether, allyl ether or butenyl ether groups; or dicyclopentadienyl ester, norbornenyl ester, isoprenyl ester, isopropenyl ester, allyl ester or butenyl ester groups.

4. The process of claim 3, wherein the olefinically unsaturated double bonds of the binders (A 111) of the dimensionally stable particles (A11) of the powder dispersion (A1) are in (meth)acrylate groups.

5. The process of claim 1, wherein the binders (A 111) of the dimensionally stable particles (A11) of the powder dispersion (A1) are selected from the group consisting of oligomeric and polymeric epoxy (meth)acrylates, urethane (meth)acrylates, and carbonate (meth)acrylates.

6. The process of claim 5, wherein the binder (A 111) of the dimensionally stable particles (A11) of the powder dispersion (A1) is an oligomeric or polymeric urethane (meth)acrylate.

7. The process of claim 1, wherein the dimensionally stable particles (A11) of the powder dispersion (A1) have a z-mean average particle size as measured by photon correlation spectroscopy of 80 to 400 nm.

8. The process of claim 1, wherein the powder dispersion (A1) further comprises at least one additive (A112) selected from the group consisting of salts which can be decomposed thermally substantially without residue; binders other than the binders (A 111) and curable physically, thermally and/or with actinic radiation; neutralizing agents; thermally curable crosslinking agents; thermally curable reactive diluents; reactive diluents curable with actinic radiation; opaque and transparent, color pigments, effect pigments; molecularly dispersibly soluble dyes; opaque fillers, transparent fillers; nanoparticles; light stabilizers; antioxidants; devolatilizers; wetting agents; emulsifiers; slip additives; polymerization inhibitors; free-radical polymerization initiators, photoinitiators, thermolabile free-radical initiators; adhesion promoters; flow control agents; film-forming assistants; rheological assistants, thickeners, structurally viscous sag control agents, SCAs; flame retardants; corrosion inhibitors; free-flow aids; waxes; siccatives; biocides; matting agents, and combinations thereof.

9. The process of claim 1, wherein the powder dispersion (A1) is prepared by dispersing the particles (A11) in an aqueous medium (A12).

10. The process of claim 9, wherein the particles (A11) are dispersed in an aqueous medium (A12) by means of a secondary dispersion process comprising
dissolving the ionically stabilizable binders (A 111) in organic solvents,
dispersing the resulting solutions in water (A12) with the aid of neutralizing agents (A112),
diluting the resulting dispersion with water (A12) to form, initially, a water-in-oil emulsion, which on further dilution undergoes inversion to form an oil-in-water emulsion, and
removing the organic solvents from the oil-in-water emulsion.

11. The process of claim 1, wherein the multicoat color and/or effect paint system comprises at least one of the group consisting of single-coat primer coats, multicoat primer coats, electrodeposition coats, corrosion control coats, antistonechip priming coats, surfacer coats, and combinations of one or more of the foregoing.

12. The process of claim 1, further comprising exposing the dried color and/or effect film (A) to actinic radiation after process step (2) and before process step (3).

13. The process of claim 1, further comprising jointly thermally curing the dried color and/or effect film (A) and the transparent layer (B) in process step (4).

14. The process of claim 1, further comprising jointly curing the dried color and/or effect film (A) and the transparent layer (B) thermally and with actinic radiation in process step (4).

15. The process of claim 14, wherein UV radiation is used as actinic radiation.
